(19) United States
(12) Patent Application Publication
(10) Pub. No.: US 2006/0286475 A1
(43) Pub. Date: Dec. 21, 2006

(54) Developing agent and image forming apparatus using the same

(75) Inventor: Hiroshi Kawaguchi, Ashigarakami-gun (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/154,819

(22) Filed: Jun. 17, 2005

(51) Int. Cl. G03G 9/08

(52) U.S. Cl. 430/108.6; 430/111.4; 430/109.3; 430/109.4; 430/108.4; 430/108.8

(57) ABSTRACT

Disclosed is a developing agent, wherein temperature T2, at which the developing agent exhibits a viscosity of 0.5×10⁵ (Pa·s) after receipt of a thermal history that, after once being heated at a prescribed temperature, the developing agent is cooled to room temperature, falls within a range of 100 to 140° C., temperature T1, at which the developing agent exhibits a viscosity of 0.5×10⁵ (Pa·s) before receipt of the thermal history, falls within a range of 100 to 150° C., and the difference T2−T1 is 0 to 10° C.

### BACKGROUND OF THE INVENTION

The present invention relates to an image-forming apparatus for developing an electrostatic latent image in an electrophotographic method, an electrostatic printing method, etc., and to a developing agent used in the image-forming apparatus.

The heat roll fixing method is advantageous over other fixing methods in that it is possible to obtain a fast image at a high rate, that the energy efficiency is high, and that the detrimental effect given by the evaporation of, for example, a solvent to the environment is small.

On the other hand, it is pointed out that the heat roll fixing method is defective in that a so-called “offset phenomenon”, i.e., the phenomenon that the toner image is brought into direct contact with the fixing roll or the fixing belt, tends to be generated easily.

The offset toner that is heated on and fused to the heat roller receives a thermal history that the fused toner is once cooled to room temperature if the power supply of the image-forming apparatus is turned off. Then, if the power supply is turned on later, the offset toner is heated again to temperatures at which the toner can be fixed to the recording medium. Further, if the heat roller is left at the fixing temperature for a long time without allowing a recording paper sheet to pass over the heat roller, the offset toner is thermally fixed to the heat roller. The thermally fixed toner causes formation of a defective image.

A measure for overcoming the offset phenomenon described above is proposed in, for example, Japanese Patent Disclosure (Kokai) No. 11-143114. Specifically, it is proposed to use two kinds of waxes differing from each other in thermal properties in order to prevent the offset phenomenon. However, the measure proposed in this prior art is incapable of producing a sufficient effect.

The offset problem is derived from the situation that the toner once receiving the thermal history exhibits melting properties differing from those of the toner before receiving the thermal history.

In general, the temperature at which toner that has not received the thermal history exhibits viscosity α is higher than the temperature at which the toner that has received the thermal history exhibits viscosity α. In other words, the toner that has received the thermal history exhibits a viscosity higher than that of the toner that has not received the thermal history, if the comparison is made on the basis of the same temperature.

As described above, the toner before that has received the thermal history exhibits a prescribed viscosity at the temperature at which the fixing can be performed so as to permit the toner to be fixed to the paper sheet. However, the toner tends to form an offset on the heat roller. What should be noted is that the toner that has received the thermal history so as to form an offset gives rise to the problem that, if heated again to the fixing temperature after once being cooled to room temperature, the viscosity of the toner is not lowered sufficiently so as to cause the toner to be moved from the heat roller onto the recording paper sheet.

### BRIEF SUMMARY OF THE INVENTION

An object of the present invention, which has been achieved in view of the situation described above, is to provide a developing agent excellent in resistance to the offset phenomenon and capable of forming an image of good quality.

Another object of the present invention is to provide a image-forming apparatus capable of forming an image of good quality without giving rise to the offset phenomenon.

According to the present invention, there is provided a developing agent comprising toner particles containing a coloring agent and a binder resin, wherein temperature T2, at which the developing agent exhibits a viscosity of 0.5×10⁵ (Pa·s) after receipt of the thermal history that, after once heated at a prescribed temperature, the developing agent is cooled to room temperature, is 100 to 140° C., temperature T1, at which the developing agent exhibits a viscosity of 0.5×10⁵ (Pa·s) before receipt of the thermal history, is 100 to 150° C., and the difference between the temperature T2 and the temperature T1, i.e., T2−T1, is 0 to 10° C.

Further, according to the present invention, there is provided a image-forming apparatus, comprising an image carrier; a developing device arranged to face the image carrier, having a developing agent including a toner containing a coloring agent and a binder resin, and serving to develop an electrostatic latent image formed on the image carrier in the form of forming a developing agent image on the image carrier; a transfer device for transferring the developing agent image formed on the image carrier onto a transfer medium; and a fixing device including a heating member for heating the transferred developing agent image so as to soften the developing agent image and fix the softened developing agent image onto the transfer medium;

wherein temperature T2, at which the developing agent exhibits a viscosity of 0.5×10⁵ (Pa·s) after receipt of the thermal history that, after once being heated at a prescribed temperature, the developing agent is cooled to room temperature, is 100 to 140° C., temperature T1, at which the developing agent exhibits a viscosity of 0.5×105 (Pa·s) before receipt of the thermal history, is 100 to 150° C., and the difference between the temperature T2 and the temperature T1, i.e., T2−T1, is 0 to 10° C.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows as an example the construction of the image-forming apparatus of the present invention.

### DETAILED DESCRIPTION OF THE INVENTION

The developing agent of the present invention contains a coloring agent and a binder resin. The melting properties of the developing agent before and after receipt of the thermal history under prescribed conditions are specified in the present invention.

The melting properties of the developing agent are represented by the required heating temperature, i.e., the temperature required for melting the developing agent to exhibit a viscosity of 0.5×10⁵ (Pa—s). In the present invention, T2−T1 is defined to fall within a range of 0 to 10° C., where T1 denotes the required heating temperature noted above in respect of the developing agent before receipt of the thermal history, and T2 denotes the required heating temperature noted above in respect of the developing agent after receipt of the thermal history.

Also, the image-forming apparatus of the present invention comprises an image carrier; a developing device arranged to face the image carrier, containing the developing agent defined above, and serving to develop an electrostatic latent image formed on the image carrier so as to form a developing agent image on the image carrier; a transfer device for transferring the developing agent image formed on the image carrier onto a transfer medium; and a fixing device including a heating member for heating the transferred developing agent image so as to soften the developing agent image and fix the softened developing agent image to the transfer medium.

As described above, the developing agent is defined in the present invention such that the difference in temperature does not exceed a prescribed level between the temperature at which the developing agent not receiving the thermal history exhibits a prescribed viscosity and the temperature at which the developing agent after receipt of the thermal history at least once exhibits the prescribed viscosity.

According to the present invention, a developing agent that permits suppressing the change in the melting properties caused by the thermal history is used. As a result, even if the developing agent exhibits an offset phenomenon on the heating member so as to receive the thermal history, the viscosity of the developing agent is lowered to permit the developing agent to be moved from the heating member included in the fixing device onto, for example, a recording material even if the developing agent once cooled to room temperature is heated again to the fixing temperature. It follows that the developing agent exhibiting the offset phenomenon is not thermally fixed to the heating member so as to form a good image.

It is possible to impart a thermal history to the developing agent used in the present invention by cooling the developing agent heated at, for example, 185° C. for 4 hours to room temperature.

The developing agent of the present invention comprises a toner containing a coloring agent and a binder resin. In the present invention, it is possible to use any of a developing agent formed of a single component and a developing agent formed of two components. In the case of the developing agent formed of two components, it is possible to add a carrier to the toner containing a coloring agent and a binder resin.

It is possible for the toner to include toner particles each containing a coloring agent and a binder resin.

It is possible to add optionally additives such as silica particles and titanium particles to the surface of the toner particle.

The binder resin used in the present invention includes, for example, a polyester resin and a styrene-acrylic resin.

The polyester resin used in the present invention can be obtained by using a monomer containing a carboxylic acid component consisting of polyvalent carboxylic acid compounds having a valency of at least two and an alcohol component consisting of polyvalent alcohols having a valency of at least two. The acid components used for synthesizing the polyester resin include, for example, fumaric acid, maleic acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, or donecenyl succinic acids having an alkyl group having 1 to 20 carbon atoms or an alkenyl group having 2 to 20 carbon atoms substituted therein such as dodecenyl succinic acid and octyl succinic acid, derivatives thereof such as anhydrides of these acids and alkyl ester of these acids. The alcohol components used for synthesizing the polyester resin used in the present invention include, for example, aliphatic polyols such as ethylene glycol, propylene glycol, 1,4-butane diol, 1,3-butane diol, 1,5-pentane diol, 1,6-hexane diol, neopentene glycol, glycerin, trimethylol ethane, trimethylol propane, and pentaerythritol; alicyclic polyols such as 1,4-cyclohexane diol and 1,4-cyclohexane dimethanol; and an ethylene oxide such as bisphenol A or a propylene oxide adduct.

Also, the styrene-acrylic resin used in the present invention includes, for example, polymers of styrenes, copolymers between styrenes and dienes, and copolymers between styrenes and alkyl (meth)acrylate.

The change in the melting properties of the developing agent before and after receipt of the thermal history can be controlled by controlling the molecular weight of the binder resin described above, by controlling the selection and the mixing ratio of the monomer species, and by controlling the acid components of the resin.

It is also possible to use a mixture of at least two different resins. For example, it is possible to mix a polyester resin with a styrene-acrylic resin for use in the present invention as a binder resin.

Where the polyester resin is mixed with the styrene-acrylic resin, it is possible to mix these different resins at the mixing ratio of 0.5:9.5 to 9.5:0.5.

Where the polyester resin is mixed at a mixing ratio higher than the range given above, it is possible for the styrene-acrylic resin contained in the resin mixture to fail to exhibit the effect of improving the storage capability of the developing agent. Also, where the toner is manufactured by the pulverizing method, it is difficult to obtain a sufficient effect of improving the pulverizing efficiency.

Where the styrene-acrylic resin is mixed in a mixing ratio higher than the range given above, it is difficult for the polyester resin to produce sufficiently its effect of improving the resistance of the developing agent to the offset phenomenon.

The coloring agent used in the present invention includes, for example, carbon black, a cyan pigment available on the market, a yellow pigment available on the market, and a magenta pigment available on the market.

It is possible to add a wax to the toner particles included in the developing agent of the present invention.

The wax used in the present invention includes, for example, a propylene wax, a polyethylene wax, a rice wax, and a carnauba wax.

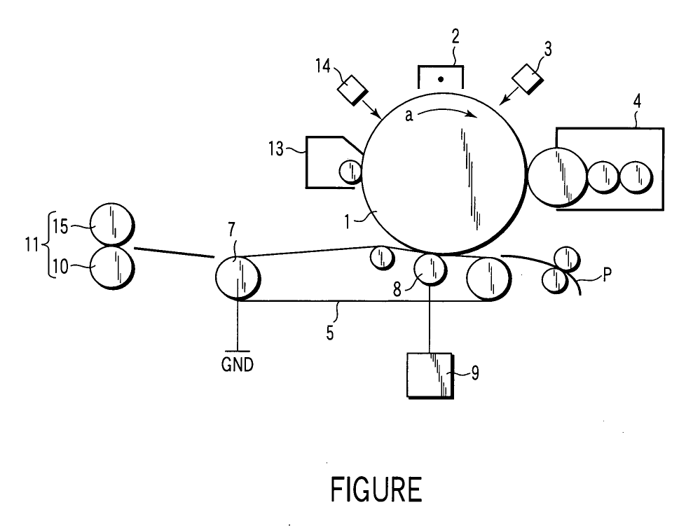

FIG. 1 schematically shows as an example the construction of an image-forming apparatus of the present invention.

As shown in the drawing, the image-forming apparatus of the present invention comprises a photoreceptor drum 1 having a surface roughness Rz, which is not larger than 1, and rotatable in a direction denoted by an arrow “a”. A surface potential of 500 to 800 V is applied uniformly to the photoreceptor drum 1 by a charging device 2. An electrostatic latent image is formed on the photoreceptor drum 1 by an exposure device 3. The electrostatic latent image formed on the photoreceptor drum 1 is made visible by a toner that is charged negative by a developing device 4. The developing agent used in the developing device 4 comprises toner particles containing, for example, a coloring agent and a binder resin, and silica particles added to the surfaces of the toner particles. Temperature T2, at which the developing agent, after receipt of a thermal history that the developing agent heated at 185° C. for 4 hours is cooled to room temperature, exhibits a viscosity of 0.5×10⁵ (Ps·s), falls within a range of 100 to 140° C. Also, temperature T1, at which the developing agent before receipt of the thermal history noted above exhibits a viscosity of 0.5×10⁵ (Pa·s), falls within a range of 100 to 150° C. In addition, the difference between temperature T2 noted above and temperature T1 above, i.e., T2−T1, is 0 to 10° C. A belt 5 is allowed to abut against the photoreceptor drum 1 downstream of the developing device 4. Also, a paper sheet P used as a transfer medium is interposed between the belt 5 and the photoreceptor drum 1. Under this condition, the toner image formed on the photoreceptor drum 1 is transferred onto the paper sheet P by the bias voltage of, for example, +300 to 5 kV applied from a high voltage power supply 9 to the belt 5. The belt 5 is formed of an elastic belt having a volume resistivity of, for example, 10⁸ to 10¹² Ω·cm and is supported by a plurality of rollers including a roller 7. If the roller 7 is driven, the belt 5 is rotated at an area moving rate substantially equal to that of the photoreceptor drum 1. A conductive elastic roller 8 having a volume resistivity of 10² to 108 Ω·cm is used as a power supply member so as to make it possible to supply an electric power from the back surface of that region of the belt 5 which is in contact with the photoreceptor drum 1. In the ordinary printing, each of the belt 5 and the photoreceptor drum 1 is driven under the state that the belt 5 and the photoreceptor drum 1 are positioned apart from each other, and the belt 5 and the photoreceptor drum 1 are allowed to abut against each other after the belt 5 and the photoreceptor drum 1 are rendered substantially equal to each other in the area moving rate. Simultaneously with the application of a transfer bias from the power supply 9 to the power supply roller 8, the paper sheet P used as a transfer medium is transferred so as to reach a transfer nipping region. The paper sheet P passing through the transfer nipping region between the photoreceptor drum 1 and the power supply roller 8 is electrostatically sucked by the belt 5. However, since the driving roller 7 has a large curvature, the tip of the paper sheet P is moved away from the belt 5 on the most downstream side of the belt unit so as to be transferred into a fixing device 11 through a guide member.

In a downstream region of the transfer nip on the photoreceptor drum 1, the extra toner is removed by a cleaning means 13 and, then, the photoreceptor drum 1 is destaticized by a destaticizing means 14.

In the fixing device 11, the toner image is fixed to the paper sheet P by a heat roller 15 and a pressurizing roller 10 at the fixing temperature of 130 to 230° C. The fixing device 11 used in this embodiment is of an oil-less type in which an oil replenishing mechanism is not mounted.

### EXAMPLES

The present invention will now be described more in detail with reference to Examples of the present invention.

### Examples 1 to 4

The toner particle materials given below were prepared:

| | |
|---|---|
| Polyester series resin | 92.5 wt % |
| Polypropylene wax | 2.0 wt % |
| Carbon black | 5.0 wt % |
| Charging controller | 0.5 wt % |

The polyester used in Examples 1 to 4 was synthesized by polymerization using succinic acid and terephthalic acid as the acid components and by controlling the molecular weight of the resultant polymer so as to permit the synthesized polymer to exhibit an appropriate viscosity and melting properties.

The materials given above were melted and kneaded so as to obtain a kneaded mass. The kneaded mass thus obtained was roughly pulverized and, then, finely pulverized, followed by classifying the resultant powdery material so as to obtain toner particles having an average particle diameter of 8 μm.

Then, additives consisting of 0.5 parts by weight of silica and 0.5 parts by weight of titanium were prepared relative to 100 parts by weight of the toner particles thus obtained and added to the surfaces of the toner particles so as to obtain a desired toner.

In the next step, measured was the heating temperature required for allowing the toner thus obtained to exhibit a viscosity of 0.5×10⁵ (Pa·s).

Also measured was the temperature required for allowing the toner to exhibit a viscosity of 0.5×10⁵ (Pa·s) after receipt of a thermal history such that the toner was kept heated at 185° C. for 4 hours, followed by cooling the toner to room temperature.

The viscosity was measured by the temperature elevation method by using a flow tester manufactured by Shimazu K. K. under the conditions that the temperature elevation rate was set at 2.5° C./min, the outlet port had a diameter of 1.0 mm and a length of 1.0 mm, and the load was set at 5 kg.

Table 1 shows the heating temperature required for allowing the toner before and after receipt of the thermal history to exhibit a viscosity of 0.5×10⁵ (Pa·s).

Also, the fixing of the toner to the heat roller included in the fixing device, the fixing performance, and the blocking of the toner particles during the storage under high temperatures were measured in respect of the obtained toner as follows:

Toner Fixing:

The toner is forcedly allowed to exhibit an offset phenomenon on the heat roller, followed by leaving the toner to stand for 4 hours under the copying-ready state without rotating the heat roller. In this case, the temperature of the heat roller is controlled to exhibit a surface temperature of 185° C. Four hours later, the heating lamp is turned off and the fixing device is left to stand so as to cool the entire fixing device to room temperature. After being cooled to room temperature, the fixing device is heated again to 185° C. and, then, a blank paper sheet is passed through the fixing device so as to examine whether the offset toner on the heat roller is moved onto the paper sheet, thereby confirming the toner fixing on the heat roller.

Incidentally, a Toshiba DP2320 was used as the image-forming apparatus, and the result of the toner fixing test is given by the marks in which the mark “◯” denotes that the toner fixing on the heat roller was not recognized after the test, with the mark “×” denoting that the toner fixing on the heat roller was recognized after the test.

Fixing Performance:

The result of the fixing performance test is given by the marks in which the mark “◯” denotes that the remaining rate of the image concentration after the rubbing of the image fixed to the paper sheet with a fastness tester was not lower than 70%, with the mark “×” denoting that the remaining rate of the image concentration noted above was lower than 70%.

Blocking During Storage Under High temperatures:

The result of the test on the blocking of the toners caused by the storage under high temperatures is given by the marks “◯” and “×” in Table 1. The mark “◯” denotes that the blocking was not recognized when the toner was left to stand for 8 hours under an environment of 55° C., with mark “×” denoting that the blocking was recognized when the toner was left to stand for 8 hours under an environment of 55° C.

### Example 5

A toner was obtained as in Example 1, except that an acrylic-styrene series resin was used in place of the polyester resin used in Example 1.

A styrene-alkyl(meth)acrylate copolymer was used as the acrylic-styrene series resin, and the molecular weight of the copolymer was controlled to allow the copolymer to exhibit an appropriate viscosity.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained. Table 1 also shows the results.

### Example 6

A toner was obtained as in Example 1, except that the amount of the polyester resin was decreased to 62.5% by weight and that a styrene-acrylic series resin as in Example 5 was further added in an amount of 30% by weight.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained. Table 1 also shows the results.

### Comparative Example 1

A toner was obtained as in Example 1, except that the molecular weight of the polyester resin was controlled in the polymerizing step in a manner to allow the synthesized polyester resin to exhibit an inappropriate viscosity and melting properties.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained.

Table 1 also shows the results.

### Comparative Example 2

A toner was obtained as in Example 1, except that fumaric acid and terephthalic acid were used in place of the succinic acid and the terephthalic acid used in Example 1 as the acid components in the synthesizing process of the polyester resin, and the molecular weight of the polyester resin was controlled to cause the polyester resin to exhibit an inappropriate viscosity and melting properties.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained. Table 1 also shows the results.

### Comparative Example 3

A toner was obtained as in Comparative Example 1, except that the viscosity and the melting properties of the toner were changed.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained. Table 1 also shows the results.

### Comparative Examples 4 to 7

Toners were obtained as in Comparative Example 2, except that the viscosity and the melting properties of the toner were changed.

A thermal history was imparted to the obtained toner, and measured was the temperature required for allowing the toner before and after receipt of the thermal history to exhibit a viscosity of 0.5×10⁵ (Pa·s)

Also, the fixing performance and the blocking of the toner during the storage under high temperatures were measured and evaluated as in Example 1 in respect of the toners thus obtained. Table 1 also shows the results.

### Comparative Example 8

A toner was obtained as in Example 1, except that 37.5% by weight of a styrene-acrylic series resin equal to that used in Example 5 except that the molecular weight of the resin was controlled to allow the resin to exhibit inappropriate viscosity and melting properties, and 55% by weight of a magnetic powder were used in place of the polyester series resin used in Example 1.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained. Table 1 also shows the results.

### Comparative Example 9

A toner was obtained as in Example 1, except that 30% by weight of a styrene-acrylic series resin equal to that used in Comparative Example 8 and 62.5% by weight of a polyester resin equal to that used in Comparative Example 2 were used in place of the polyester series resin used in Example 1.

A thermal history was imparted to the obtained toner, and measured was the temperature required for allowing the toner before and after receipt of the thermal history to exhibit a viscosity of 0.5×10⁵ (Pa·s).

Also, the fixing performance and the blocking of the toner during the storage under high temperatures were measured and evaluated as in Example 1 in respect of the toner thus obtained.

Table 1 also shows the results.

TABLE 1

| | | | | |
|---|---|---|---|---|
| Before | After | | | |
| thermal | thermal | Toner | Fixing | Blocking during storage |
| history | history | fixation | performance | under high temperatures |

Examples

| | | | | | |
|---|---|---|---|---|---|
| 1 | 100° C. | 100° C. | ◯ | ◯ | ◯ |
| 2 | 100° C. | 110° C. | ◯ | ◯ | ◯ |
| 3 | 140° C. | 140° C. | ◯ | ◯ | ◯ |
| 4 | 140° C. | 150° C. | ◯ | ◯ | ◯ |
| 5 | 135° C. | 145° C. | ◯ | ◯ | ◯ |
| 6 | 120° C. | 130° C. | ◯ | ◯ | ◯ |

Comparative
Examples

| | | | | | |
|---|---|---|---|---|---|
| 1 | 99° C. | 100° C. | ◯ | ◯ | X |
| 2 | 99° C. | 110° C. | X | ◯ | X |
| 3 | 141° C. | 141° C. | ◯ | X | ◯ |
| 4 | 141° C. | 152° C. | X | X | ◯ |
| 5 | 100° C. | 111° C. | X | ◯ | ◯ |
| 6 | 140° C. | 151° C. | X | ◯ | ◯ |
| 7 | 110° C. | 121° C. | X | ◯ | ◯ |
| 8 | 135° C. | 146° C. | X | ◯ | ◯ |
| 9 | 120° C. | 131° C. | X | ◯ | ◯ |

As shown in Table 1, in each of Examples 1 to 6, the temperature at which the toner before and after receipt of a thermal history is allowed to exhibit a viscosity of 0.5×10⁵ (Pa·s) falls within an appropriate range. In addition, the difference in temperature at which the toner is allowed to exhibit a viscosity of 0.5×10⁵ (Pa·s) between the toner before receipt of the thermal history and the toner after receipt of the thermal history is not larger than 10° C. Under the circumstances, the toner for each of Examples 1 to 6 was not fixed to the heat roller, was fixed sufficiently to the paper sheet, and blocking did not take place even if the toner was left to stand under a high temperature environment.

On the other hand, the toner for each of Comparative Examples 1 and 2 was found to exhibit the properties that the viscosity of the toner was lowered under low temperatures. In these cases, the toners were fixed to the paper sheet satisfactorily. However, it has been found that, if left to stand under a high temperature environment, the toner particles were fused to each other so as to bring about the blocking phenomenon. Also, in Comparative Example 2, the difference in temperature at which the toner is allowed to exhibit a viscosity of 0.5×10⁵ (Pa·s) between the toner before receipt of the thermal history and the toner after receipt of the thermal history was found to be 11° C., with the result that the toner was fixed to the heat roller. In Comparative Examples 3 and 4, a high temperature was required for lowering the viscosity of the toner, with the result that the blocking phenomenon did not take place. However, the toner was not fixed sufficiently to the paper sheet so as to give rise to an unfixed image. Further, in Comparative Example 4, the toner was fixed to the heat roller as in Comparative Example 2. Still further, in Comparative Examples 5 to 8, the toner before receipt of a thermal history was allowed to exhibit a viscosity of 0.5×10⁵ (Pa·s) under temperatures under which an unfixed image and the blocking did not take place. However, the toner was found to be fixed to the heat roller for the same reason as that for Comparative Examples 2 and 4.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent containing a coloring agent and a binder resin, wherein temperature T2, at which the developing agent exhibits a viscosity of 0.5×10⁵ (Pa—s) after receipt of a thermal history that, after once heated at a given temperature, the developing agent is cooled to room temperature, falls within a range of 100 to 140° C., temperature T1, at which the developing agent exhibits a viscosity of 0.5×10⁵ (Pa·s) before receipt of the thermal history, falls within a range of 100 to 150° C., and the difference T2−T1 is 0 to 10° C.

2. The developing agent according to claim 1, wherein the heating included in the thermal history is carried out at 185° C. for 4 hours.

3. The developing agent according to claim 1, wherein a resin selected from the group consisting of a polyester resin, a styrene-acrylic resin, and a mixture of the polyester resin and the styrene-acrylic resin mixed at a mixing ratio of 0.5:9.5 to 9.5:0.5 is used as the binder resin.

4. The developing agent according to claim 1, wherein the coloring agent and the binder resin are contained in the toner particles, and developing agent further comprises at least one additive of silica particles and titanium particles, added to the surfaces of the toner particles.

5. The developing agent according to claim 1, further comprising at least one wax selected from the group consisting of a polypropylene wax, a polyethylene wax, a rice wax and a carnauba wax.

6. An image-forming apparatus, comprising an image carrier; a developing device arranged to face the image carrier, including a developing agent containing a coloring agent and a binder resin, and serving to develop an electrostatic latent image formed on the image carrier to form a developing agent image on the image carrier; a transfer device for transferring the developing agent image formed on the image carrier onto a transfer medium; and a fixing device including a heating member for heating the transferred developing agent image to soften the developing agent image and fix the softened developing agent image onto the transfer medium;
wherein temperature T2, at which the developing agent exhibits a viscosity of 0.5×10⁵ (Pa·s) after receipt of the thermal history that, after once heated at a given temperature, the developing agent is cooled to room temperature, falls within a range of 100 to 140° C., temperature T1, at which the developing agent exhibits a viscosity of 0.5×10⁵ (Pa·s) before receipt of the thermal history, falls within a range of 100 to 150° C., and the difference T2−T1 is 0 to 10° C.

7. The image-forming apparatus according to claim 6, wherein the heating included in the thermal history is carried out at 185° C. for 4 hours.

8. The image-forming apparatus according to claim 6, wherein a resin selected from the group consisting of a polyester resin, a styrene-acrylic resin, and a mixture of the polyester resin and the styrene-acrylic resin mixed at a mixing ratio of 0.5:9.5 to 9.5:0.5 is used as the binder resin.

9. The image-forming apparatus according to claim 6, wherein the fixing device heats the transferred developing agent image under temperatures of 130 to 230° C.

10. The image-forming apparatus according to claim 6, wherein the coloring agent and the binder resin are contained in the toner particles, and the developing agent further comprises at least one additive of silica particles and titanium particles, added to the surfaces of the toner particles.

11. The developing device according to claim 6, further comprising at least one wax selected from the group consisting of a polypropylene wax, a polyethylene wax, a rice wax and a carnauba wax.
